(19) United States
(12) Patent Application Publication
(10) Pub. No.: US 2019/0361278 A1
(43) Pub. Date: Nov. 28, 2019

(54) LIQUID CRYSTAL DISPLAY DEVICE

(71) Applicants: BOE Technology Group Co., Ltd., Beijing (CN); Beijing BOE Display Technology Co., Ltd., Beijing (CN)

(72) Inventors: Lili JIA, Beijing (CN); Hao ZHOU, Beijing (CN); Wei ZHANG, Beijing (CN); Weihao HU, Beijing (CN)

(21) Appl. No.: 15/763,907

(22) PCT Filed: Sep. 13, 2017
(86) PCT No.: PCT/CN2017/101550

§ 371 Date: Mar. 28, 2018

(30) Foreign Application Priority Data
Feb. 21, 2017 (CN) 201720155123.1

(51) Int. Cl. G02F 1/1362; G02F 1/1335

(52) U.S. Cl. CPC G02F 1/1362; G02F 1/133308; G02F 1/133514

(57) ABSTRACT

Embodiments of this disclosure discloses a liquid crystal display device including a liquid crystal panel and a chip on film, wherein the liquid crystal panel includes an array substrate and a color filter substrate which are arranged opposite to each other, an end face of the color filter substrate is flush with an end face of the array substrate, and the chip on film is located on the end faces of the color filter substrate and the array substrate.

This application is a National Stage of International Application No. PCT/CN2017/101550, filed Sep. 13, 2017, which claims the benefit of Chinese Patent Application No. 201720155123.1, filed with the Chinese Patent Office on Feb. 21, 2017 and entitled “A liquid crystal display device”, both of which are hereby incorporated by reference in their entireties.

### FIELD

Embodiments of this disclosure relate to the field of display technologies, and particularly to a liquid crystal display device.

### BACKGROUND

A liquid crystal display device has been widely applied in the field of display technologies due to its characteristics of a low weight, a small thickness, low power consumption, and high contrast, and is commonly used as a display of a desktop computer, a portable computer, and a wall-installed TV set. There are frame edges with different sizes on the peripheries of display screens in the majority of liquid crystal display devices existing in the market, and a liquid crystal display device with a large display area including a narrow frame edge or no frame edge has been increasingly favored by respective panel manufacturers and display terminal manufacturers due to its pleasing and vogue appearance.

### SUMMARY

At least one embodiment of this disclosure provides a liquid crystal display device including a liquid crystal panel and a chip on film, wherein the liquid crystal panel includes an array substrate and a color filter substrate which are arranged opposite to each other, an end face of the color filter substrate is flush with an end face of the array substrate, and the chip on film is located on the end faces of the color filter substrate and the array substrate.

The liquid crystal display device further includes a frame edge, and the liquid crystal panel is located within the frame edge, and fixed and connected with the frame edge.

The liquid crystal display device further includes a backlight source located on a side of the array substrate away from the color filter substrate, and the backlight source is located within the frame edge, and fixed and connected with the frame edge.

The backlight source includes a back plate fixed and connected with the frame edge through a bolt.

The liquid crystal display device further includes a scattering plate located within the frame edge, and between the array substrate and the backlight source, and the scattering plate is fixed and connected with the frame edge.

The scattering plate is affixed and fixed with the frame edge using glue.

The liquid crystal panel is affixed and fixed with the frame edge using glue.

Glue is filled between the chip on film and the frame edge.

The glue is VHB glue.

The array substrate includes electrodes extending to the end face of the array substrate, and electrically connected with the chip on film.

The electrodes are electrically connected with the chip on film through an electrically conductive silver adhesive located on the end face of the array substrate.

The frame edge is flush with a surface of the color filter substrate; the surface is on a side of the color filter substrate away from the array substrate.

### BRIEF DESCRIPTION OF THE DRAWINGS

In order to make the technical solutions according to the embodiments of this disclosure, or the related art more apparent, the drawings to which reference is made in the description of the embodiments or the related art will be introduced below briefly, and apparently the drawings to be described below are only some embodiments of this disclosure, and those ordinarily skilled in the art can further derive other drawings from these drawings here without any inventive effort.

FIG. 1 is a schematic structural diagram of a cross section of the liquid crystal display device in the related art along the edge thereof.

FIG. 2 is a schematic structural diagram of a cross section of a liquid crystal display device according to an embodiment of this disclosure.

FIG. 3 is a schematic structural diagram of a cross section of the liquid crystal display device according to the embodiment of this disclosure along the edge thereof.

FIG. 4 is a side view of a liquid crystal panel and a chip on film in FIG. 3 at a binding cross section.

FIG. 5 is a side view of the liquid crystal panel and a frame edge in FIG. 3 at the binding cross section.

### DETAILED DESCRIPTION OF THE EMBODIMENTS

In order to make the objects, technical solutions, and advantages of the embodiments of this disclosure more apparent, the technical solutions according to the embodiments of this disclosure will be described below clearly and fully with reference to the drawings in the embodiments of this disclosure. Apparently the embodiments to be described are only a part but all of the embodiments of this disclosure. Based upon the embodiments here of this disclosure, all of other embodiments which can occur to those ordinarily skilled in the art without any inventive effort shall come into the scope of this disclosure as claimed.

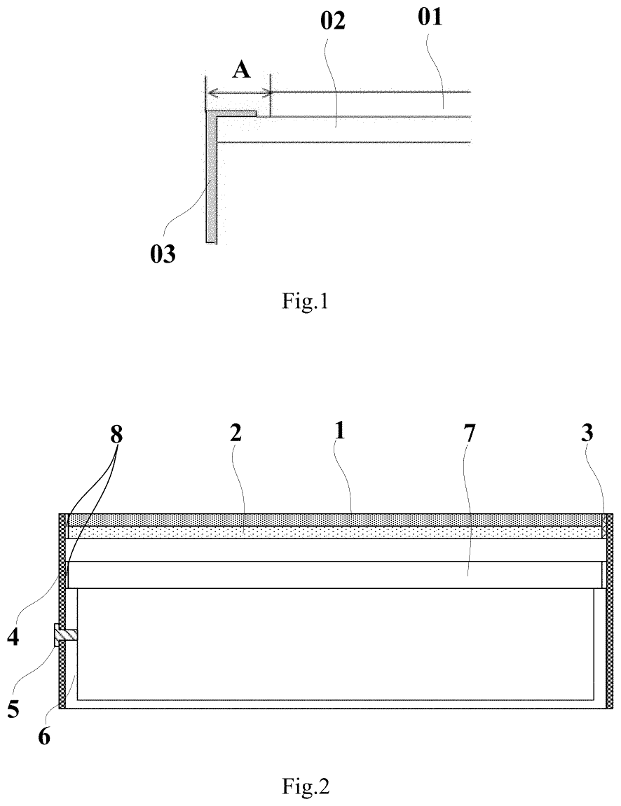

In the liquid crystal display device in the related art as illustrated in FIG. 1, a chip on film 03 is bound on the surface of an array substrate 02 facing a color filter substrate 01, and a binding area A with a width of at least 1 mm needs to be arranged on the array substrate 02, that is, the array substrate 02 needs to extend by at least 1 mm beyond the color filter substrate 01. Furthermore in the related art, the frame edge of the liquid crystal display device is generally designed to be bent in the L shape to thereby wrap and fix a liquid crystal panel and a backlight source, and since there is a physical joint of at least 2 mm between the frame edge and the backlight source, it is difficult to design the liquid crystal display device with a narrow frame edge, let along a design without any frame edge.

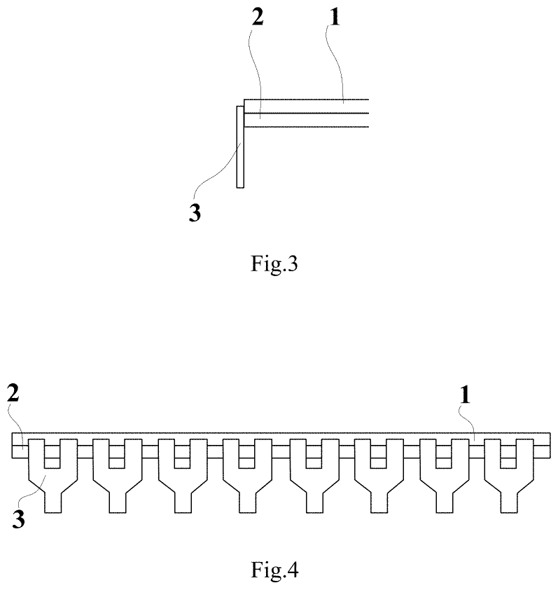

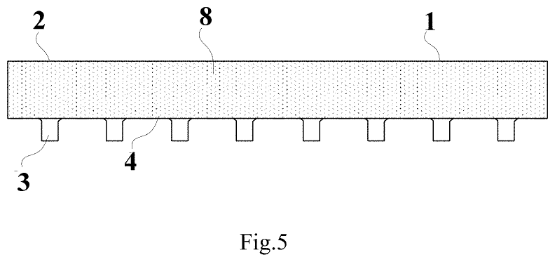

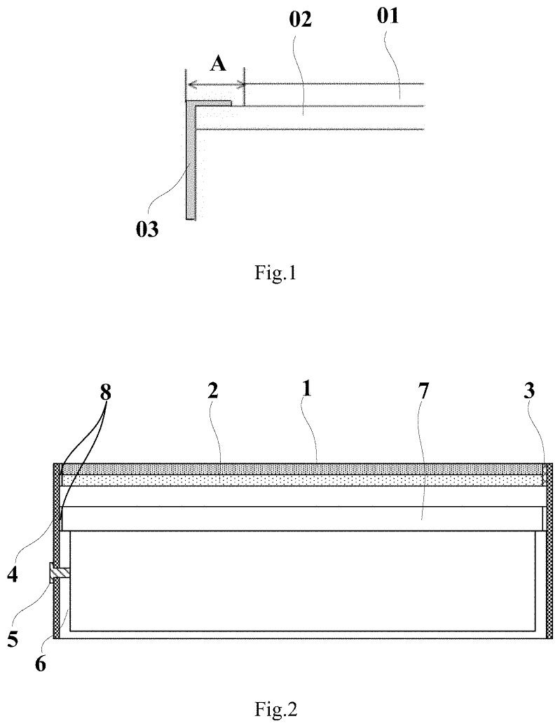

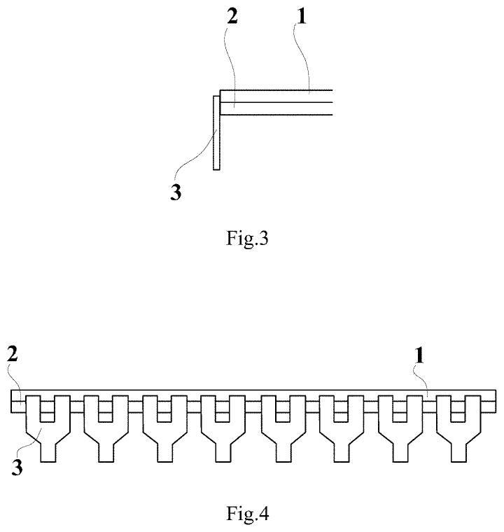

As illustrated in FIG. 2 and FIG. 3, a liquid crystal display device according to an embodiment of this disclosure includes a liquid crystal panel and a chip on film 3, where the liquid crystal panel includes an array substrate 2 and a color filter substrate 1 which are arranged opposite to each other, an end face of the color filter substrate 1 is flush with an end face of the array substrate 2, and the chip on film 3 is located on the end faces of the color filter substrate 1 and the array substrate 2.

In the liquid crystal display device above, since the end face of the color filter substrate 1 is flush with the end face of the array substrate 2, the chip on film 3 is bound on the end faces of the color filter substrate 1 and the array substrate 2, and as compared with the related art above, no binding area will be arranged on the surface of the array substrate 2 on the side thereof proximate to the color filter substrate 1, so that the width of the frame edge of the liquid crystal display device can be reduced by at least 1 mm, and furthermore the extreme of the 2 mm physical joint in the display device including the screen joined with the narrow frame edge can be broken. With this design, a design without any frame edge can be further made to thereby further improve the quality of a displayed image.

As illustrated in FIG. 2 and FIG. 3, in an embodiment of this disclosure, the liquid crystal display device further includes a frame edge 4, and the liquid crystal panel is located within the frame edge 4, and fixed and connected with the frame edge 4.

Here the frame edge 4 will not be limited to any particular type of material, and for example, the frame edge can be made of a metal frame edge, a plastic frame edge, etc.

As illustrated in FIG. 2, the liquid crystal display device further includes a backlight source 6 located on the side of the array substrate 2 away from the color filter substrate 1, and the backlight source 6 is located within the frame edge 4, and fixed and connected with the frame edge 4.

Optionally the backlight source 6 includes a back plate, there is thread hole arranged on the side of the frame edge 4 proximate to the backlight source 6, and the back plate is fixed and connected with the frame edge 4 through a bolt 5. The fixing and connection of the back plate with the frame edge 4 will not be limited to fixing using the bolt 5, but the back plate can alternatively be engaged, affixed, etc., with the frame edge 4.

Furthermore the liquid crystal display device can further include a scattering plate 7 located within the frame edge 4, and between the array substrate 2 of the liquid crystal display panel, and the backlight source 6, and the scattering plate 7 is fixed and connected with the frame edge 4.

In the liquid crystal display device according to the embodiment above, as illustrated in FIG. 2 and FIG. 3, the liquid crystal panel can be affixed with the frame edge 4 using glue 8, the scattering plate 7 can be affixed with the frame edge 4 using glue 8, and the back plate can be fixed and connected with the frame edge 4 using the bolt 5. The glue 8 can be also filled between the chip on film 3 and the frame edge 4.

In the liquid crystal display device according to the embodiment above, the chip on film 3 is bound on the end faces of the color filter substrate 1 and the array substrate 2, and the frame edge 4 may not be designed to be bent, so that the size of the frame edge of the liquid crystal display device can be further reduced.

In the embodiment above, the glue 8 will not be limited to any particular material, and for example, the glue can be VHB glue. The VHB glue is a highly adhesive bonding agent which can flow, and moisten the surface of a material, and also has some cohesion strength, that is, which can resist an external force instead of being destroyed, so that it can bond together those materials to be affixed. The VHB glue can be applied directly without any physical or chemical curing process, so it can be very convenient in operation. As compared with the common mechanical connection schemes, the VHB glue can be applied without concentrating any stress, and has a higher quality of appearance, and a longer service lifetime. Various materials can be affixed together using the VHB glue to thereby alleviate a deformation and a stress arising from their different thermal expansion coefficients.

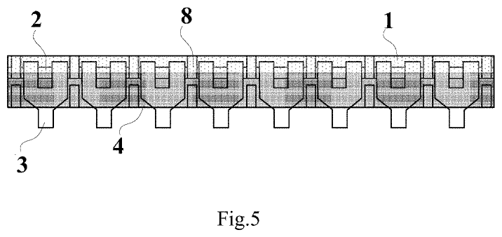

As illustrated in FIG. 3, FIG. 4, and FIG. 5, in the optional embodiment, the frame edge 4 is flush with the surface of the color filter substrate 1 on the side thereof away from the array substrate 2. Optionally the end face of the frame edge 4 proximate to the color filter substrate 1 can be ground so that the frame edge 4 is flush with the surface of the color filter substrate 1 on the side thereof away from the array substrate 2. With this design, the frame edge 4 can protect the edge of the liquid crystal panel from being damaged, and improve the yield ratio of the product, but also can maximize the screen of the liquid crystal display device for a better visual effect.

In an optional embodiment of this disclosure, the array substrate 2 includes electrodes extending to the end face of the array substrate 2, and electrically connected with the chip on film 3. Optionally the electrodes can be bound with the chip on film 3 through an electrically conductive silver adhesive located on the end face of the array substrate 2 to thereby be electrically connected therewith.

In summary, with the technical solution according to the embodiment above of this disclosure, no binding area will be arranged on the surface of the array substrate proximate to the color filter substrate, so the liquid crystal display device can be designed with a narrow frame edge or without any frame edge, thus improving the quality of a displayed image on the liquid crystal display device.

It shall be lastly noted that the foregoing embodiments are merely intended to illustrate the technical solutions according to this disclosure, but not intended to limit this disclosure thereto; and although this disclosure has been described in details in connection with the foregoing embodiments thereof, those ordinarily skilled in the art shall appreciate that they still can modify the technical solutions recited in the respective embodiments above, or make equivalent substitutions for a part of the technical features therein; and the essences of the corresponding technical solutions will not depart from the spirit and scope of the respective embodiments of this disclosure due to these modifications or substitutions.

1. A liquid crystal display device, comprising a liquid crystal panel and a chip on film, wherein the liquid crystal panel includes an array substrate and a color filter substrate which are arranged opposite to each other, an end face of the color filter substrate is flush with an end face of the array substrate, and the chip on film is located on the end faces of the color filter substrate and the array substrate.

2. The liquid crystal display device according to claim 1, wherein the liquid crystal display device further comprises a frame edge, and the liquid crystal panel is located within the frame edge, and fixed and connected with the frame edge.

3. The liquid crystal display device according to claim 2, wherein the liquid crystal display device further comprises a backlight source located on a side of the array substrate away from the color filter substrate, and the backlight source is located within the frame edge, and fixed and connected with the frame edge.

4. The liquid crystal display device according to claim 3, wherein the backlight source comprises a back plate fixed and connected with the frame edge through a bolt.

5. The liquid crystal display device according to claim 3, wherein the liquid crystal display device further comprises a scattering plate located within the frame edge, and between the array substrate and the backlight source, and the scattering plate is fixed and connected with the frame edge.

6. The liquid crystal display device according to claim 5, wherein the scattering plate is affixed and fixed with the frame edge using glue.

7. The liquid crystal display device according to claim 2, wherein the liquid crystal panel is affixed and fixed with the frame edge using glue.

8. The liquid crystal display device according to claim 2, wherein glue is filled between the chip on film and the frame edge.

9. The liquid crystal display device according to claim 6, wherein the glue is VHB glue.

10. The liquid crystal display device according to claim 1, wherein the array substrate comprises electrodes extending to the end face of the array substrate, and electrically connected with the chip on film.

11. The liquid crystal display device according to claim 10, wherein the electrodes are electrically connected with the chip on film through an electrically conductive silver adhesive located on the end face of the array substrate.

12. The liquid crystal display device according to claim 2, wherein the frame edge is flush with a surface of the color filter substrate; the surface is on a side of the color filter substrate away from the array substrate.

13. The liquid crystal display device according to claim 4, wherein the liquid crystal display device further comprises a scattering plate located within the frame edge, and between the array substrate and the backlight source, and the scattering plate is fixed and connected with the frame edge.
